(19) United States
(12) Patent Application Publication
(10) Pub. No.: US 2006/0049148 A1
(43) Pub. Date: Mar. 9, 2006

(54) Method for welding together of medium and high carbon steel and stainless steel

(76) Inventor: Jen-Yu Chang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/934,420

(22) Filed: Sep. 7, 2004

(51) Int. Cl. B23K 15/00

(52) U.S. Cl. 219/121.14

(57) ABSTRACT

A method for welding together of medium and high carbon steel and stainless steel includes a decarburizing step, and an electronic beam welding step; before medium and high carbon steels and a stainless steel are joined together by means of electronic beam welding, carbons are first removed from the surfaces of the medium and high carbon steels by means of the decarburizing step such that the medium and high carbon steels are prevented from having martensite formed thereon in electronic beam welding.

### BACKGROUND OF THE INVENTION

1. Field of the Invention

The present invention relates to a method for welding together of medium and high carbon steel and stainless steel, according to which before carbon steels and a stainless steel are joined together by means of electronic beam welding, carbons are first removed from the surfaces of the carbon steels by means of a decarburizing step such that the carbon steels are prevented from having martensite formed thereon, and cracks can't occur after the electronic beam welding.

2. Brief Description of the Prior Art

Stainless steel has excellent anti-corrosion, which is mainly contributed to one of the ingredients Cr (Chromium). Besides Chromium, Nickel (Ni) and Molybdenum (Mo) are common ingredients of stainless steel, and having Nickel as one of the ingredients, stainless steel will be improved in its extendibility and formability.

Stainless steel can be grouped according to the structure, and there are three major types of stainless steels, which are Martensite, ferrite, and Austenite. And, there are lower-carbon steel, medium-carbon one, and high-carbon one when steels are grouped according to the proportion of the carbon ingredient.

Generally speaking, there are three major types of welding, arc welding, gas welding, and resistance welding. And, among various types of welding, electronic beam welding is one, in which concentrated stream of electrons impact work piece at high speed to melt the same. Because medium carbon steel and high carbon steel contain high proportion of carbon, and because electronic beam welding is performed in vacuum and with fast heating and cooling actions, martensite structure will form, on which structure hardness and stress are relatively concentrated, and the joints will crack if electronic beam welding is applied to welding of medium and high carbon steel and stainless steel. Therefore, currently electronic beam welding isn't applied to welding of medium and high carbon steel and stainless steel.

Referring to FIG. 5, which shows the relation between the hardness and residual stress of welded parts of a steel material, the higher proportion of carbon ingredient a steel material contains, the more likely the welded parts of the steel material will crack after welding. And, the lower proportion of carbon ingredient a steel material contains, the less likely the welded parts of the steel material will crack.

### SUMMARY

It is a main object of the present invention to provide a method for welding together of medium and high carbon steel and stainless steel to overcome the above disadvantages.

The method of the present invention includes a decarburizing step, and an electronic beam welding step. Before medium and high carbon steels and a stainless steel are joined together by means of electronic beam welding, carbons are first removed from the surfaces of the medium and high carbon steels by means of the decarburizing step; thus, the medium and high carbon steels are prevented from having martensite formed thereon in the electronic beam welding step.

### BRIEF DESCRIPTION OF THE DRAWINGS

The present invention will be better understood by referring to the accompanying drawings, wherein:

FIG. 1 is a flow chart of the method according to the present invention,

FIG. 2 (a) is a cross-sectional view of a medium and high carbon steel after the decarburizing action of the present invention,

FIG. 2 (b) shows the relation between the carbon content and the depth of a medium and high carbon steel after the decarburizing action,

FIG. 3 is a view of the structure of a medium and high carbon steel before the decarburizing action,

FIG. 4 is a view of the structure of a medium and high carbon steel after the decarburizing action, and

FIG. 5 shows the relation between the hardness and residual stress of welded parts of a steel material.

### DETAILED DESCRIPTION OF THE PREFERRED EMBODIMENTS

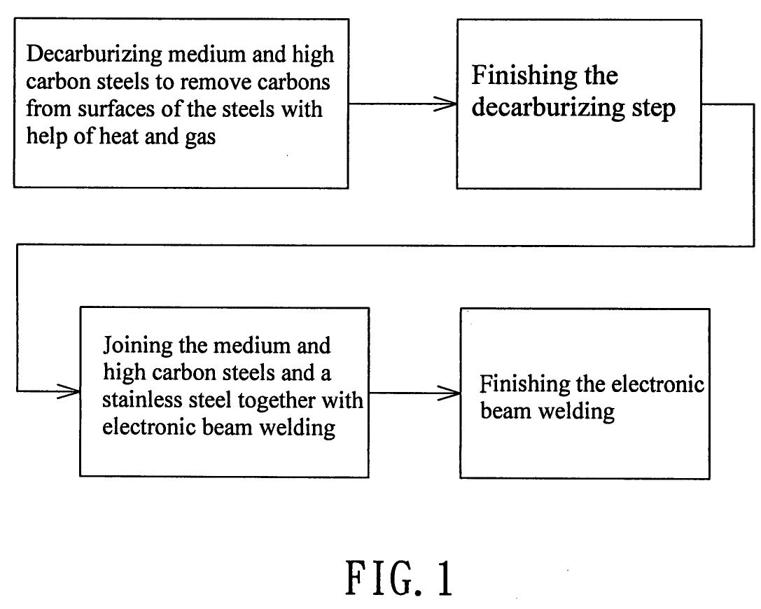

Referring to FIG. 1, a preferred embodiment of a method for welding together of medium and high carbon steel and stainless steel includes the following steps:
(1) decarburizing, in which medium and high carbon steel work pieces are heated and gas is supplied thereon such that carbons are removed from the surface of the medium and high carbon steel work pieces; the gas can be oxidizing gas, e.g. air, steam, and CO₂ (carbon dioxide), or reducing gas, e.g. H₂, or mixture of oxidizing gas and reducing gas.
(2) finishing the decarburizing step;
(3) joining the medium and high carbon steel work pieces and a stainless steel together by means of electronic beam welding; and
(4) finishing the electronic beam welding step.

In the decarburizing step, iron and carbons on the surface of medium and high carbon steels, which have high carbon content, will be oxidized when the steels are heated, and in turns, the carbons on the surfaces are reduced; oxidization will occur when O₂ (oxygen) travels into the medium and high carbon steels as well as when the carbons travel to the surface of the steels to combine with air to become CO, CO₂, and CH₄, which will escape into the air; the thickness of the oxide film and that of the carbon decarburized layer will increase as the temperature increases and as time passes.

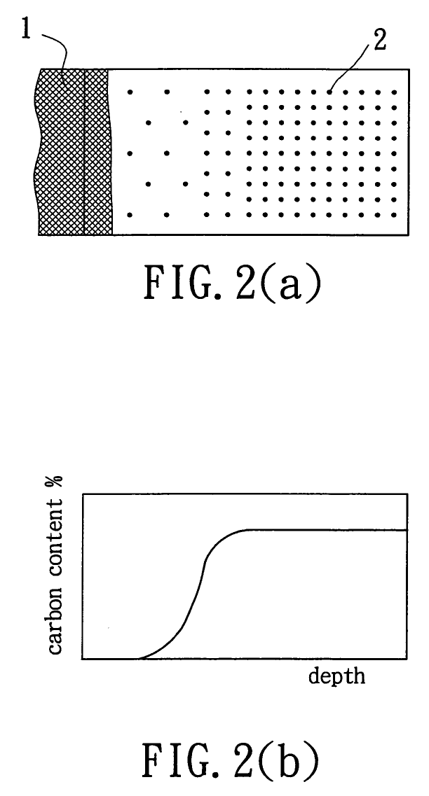

Referring to FIG. 2 (a), a cross-sectional view of a medium (high) carbon steel after the decarburizing action, the steel is formed with an oxide film 1 on the surface, and small amount of oxygen dissolves in the steel. Referring to FIG. 2 (b), which shows the relation between the carbon content and the depth of a medium (high) carbon steel after the decarburizing action, carbons are uniformly distributed inside a deeper portion of the steel. And, the nearer to the surface of the steel, the lower carbon content there will be. And, there is nearly no carbon on those portions of the steel that touch the oxide film 1.

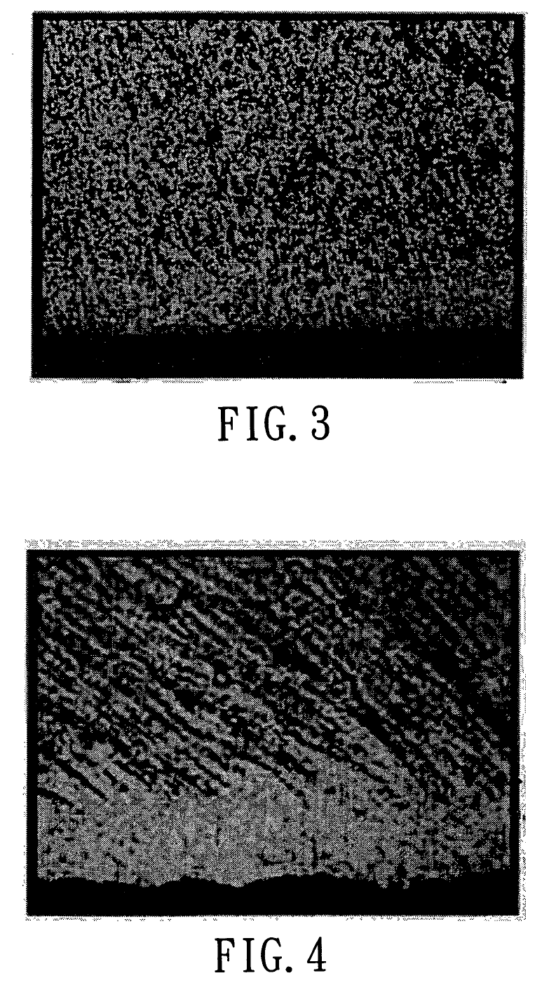

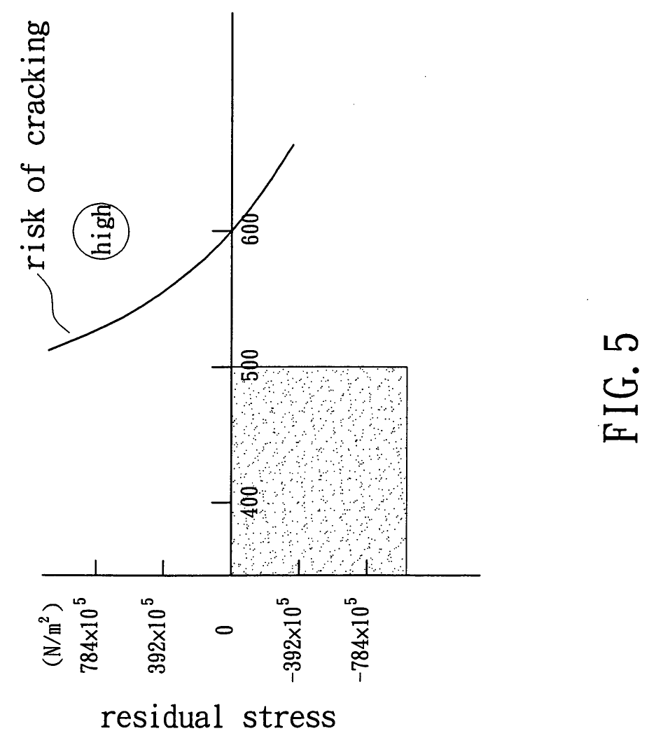

Furthermore, referring to FIGS. 3 and 4, which respectively show the structures of a medium (high) carbon steel before the decarburizing action and after the decarburizing action, it can be easily seen that the carbon contents are significantly different before and after the decarburizing action.

From the above description, it can be easily understood that including the decarburizing step, the method of the present invention can prevent martensite from forming on medium and high carbon steels when electronic beam welding is used to join the medium and high carbon steels and a stainless steel, which welding is performed in vacuum and with fast heating and cooling actions. Consequently, the weld joint is prevented from cracking.

What is claimed is:

1. A method for welding together of medium and high carbon steel and stainless steel, comprising
a decarburizing step, by means of which carbons are removed from a surface of a medium and high carbon steel; and
an electronic beam welding step, by means of which the medium and high carbon steel and a stainless steel are joined together to prevent from the generation of martensite structures.
